(19) United States
(12) Patent Application Publication
(10) Pub. No.: US 2024/0378446 A1
(43) Pub. Date: Nov. 14, 2024

(54) TEMPORAL ANOMALY DETECTION FOR MORE EFFICIENT TRAINING

(71) Applicant: GiiLD, Inc., Edina, MN (US)

(72) Inventor: Peter LIN, Worcester, MA (US)

(73) Assignee: GiiLD, Inc., Edina, MN (US)

(21) Appl. No.: 18/644,670

(22) Filed: Apr. 24, 2024

Related U.S. Application Data
(60) Provisional application No. 63/501,605, filed on May 11, 2023.

(51) Int. Cl. G06N 3/09

(52) U.S. Cl. CPC G06N 3/09

(57) ABSTRACT

Methods, systems, and apparatus, including computer programs to detect anomalous patterns in training artificial neural networks in a computing system, begins by training a neural network in a supervised manner with labeled datasets divided into training, validation and test subsets. The neural network model includes a plurality of layers each having a plurality of parameters. The system saves checkpoints of the model during training that represents different versions of a partially trained machine learning model during different stages of training. The method searches for anomalous patterns between checkpoint versions, calculates a subset of parameters in each layer and returns the results. The search results can be used to modify the neural network model improving accuracy and loss on training, validation and tests dataset.

### CROSS-REFERENCE TO RELATED APPLICATIONS

This application claims priority to U.S. Provisional Patent Application No. 63/501,605, filed May 11, 2023, the entire disclosure of which is incorporated herein by reference.

### FIELD

The present disclosure relates to improving training, analysis, and understanding of neural network models.

### BACKGROUND

Neural networks are machine learning models with one or more layers of nonlinear units to predict an output for a received input. Neural networks include an input layer, one or more hidden layers, and an output layer. The output of each hidden layer is used as an input to the next layer. Each layer of the network generates an output from the received input in accordance with the parameters of the layer.

Training neural network models using supervised and semi-supervised learning begins with obtaining a dataset, pre-processing the data to reduce noise, applying labels to each record, grouping the data to the desired statistical distribution, and segmenting the data into training, validation, and test subsets. Obtaining a sufficiently large dataset is time consuming, resource intensive, and expensive. The quality and quantity of the dataset affects the accuracy and loss of the trained model.

When training overfits the layer parameters to the training dataset, the accuracy and loss against the validation and test datasets degrades. Methods to solve overfitting focus on improving the training data, adjusting hyper parameters, and randomly resetting layer parameters. One method to improve the dataset involves generating additional data from existing records with data augmentation. After the dataset is improved, training continues until the desired accuracy and loss is obtained. Generative adversarial training can also be used to improve accuracy and loss against the validation and test datasets by generating additional training data.

However, one challenge of training neural network models is sufficiently understanding the layer parameters to explain why it underfits or overfits. Even when models have good accuracy against validation and test datasets, users get undesirable behavior or bad predictions due to this lack of understanding of the layer parameters. Continuous training is often employed to improve the training dataset with the goal of improving model generalization. But attempting to improve the training dataset without understanding why undesirable behavior persists results in slow or no progress towards better model generalization.

### SUMMARY

Aspects of the present disclosure relate to a system implemented as computer programs on one or more computers in one or more locations that determines an architecture for efficient search of anomalous patterns in neural network layer parameters. The results of the search identify the layer parameters contributing to anomalous patterns and undesirable behavior. The results of an anomaly pattern search can then be used to modify layer parameters to improve prediction accuracy and loss on training, validation, and test datasets.

In an aspect, a computer-implemented method when executed on data processing hardware causes the data processing hardware to perform operations comprising obtaining digital datasets, training a neural network model using the dataset, and saving a partially trained version of the model on a storage medium at the end of one complete iteration of the dataset (epoch). The operations performed in accordance with the method further include generating a detailed report of the accuracy and loss for the datasets for each partially trained version of the neural network model and identifying epochs with anomalous patterns between one or more epochs. The neural network model comprises a plurality of layers each comprising a plurality of parameters and the method includes searching the layer parameters of selected epochs with anomalous patterns to identify which of the layer parameters contribute to underfitting or overfitting. In addition, the operations performed in accordance with the method comprises modifying a subset of the layer parameters of a partially trained neural network model with the layer parameters of the anomaly search and determining the accuracy and loss of the modified neural network model after the modifications have been made to the layer parameters.

Other objects and features of the present invention will be in part apparent and in part pointed out herein.

### BRIEF DESCRIPTION OF THE DRAWINGS

FIG. 1 is a flow diagram illustrating an example process for creating a training dataset suitable to train a neural network model in accordance with an embodiment.

FIG. 2 is a flow diagram illustrating an example runtime process for training a neural network model in accordance with an embodiment.

FIG. 3 is a line graph illustrating an example of accuracy and loss of a training and validation dataset at the end of each epoch in accordance with an embodiment.

FIG. 4 illustrates an example data viewer showing positive and negative predictions for each record during a training process in accordance with an embodiment.

FIG. 5 is a flow diagram illustrating an example search process in accordance with an embodiment.

FIG. 6 is a flow diagram illustrating an example runtime process for profiling a layer activation of a single record in the datasets in accordance with an embodiment.

FIG. 7 is a line graph illustrating an example of improvement in accuracy and loss after applying changes to layer parameters in accordance with an embodiment.

FIG. 8 is an example heatmap graph illustrating changes to the layer parameters between two checkpoint model versions in accordance with an embodiment.

FIG. 9 is an example heatmap graph illustrating layer outputs created by the layer activation function in accordance with an embodiment.

FIG. 10 is an example scatter plot of a subset of layer parameters produced by an anomaly search function in accordance with an embodiment.

FIG. 11 illustrates an example data viewer showing positive and negative predictions for each test record for each epoch in accordance with an embodiment.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

Training of neural network models is expensive, requiring hundreds millions to billions of records to produce a model that is capable of accurate prediction on data not present in the training dataset. The sizes of the trained models have grown in the number of layers and parameters, and have achieved impressive results. However, training of neural network models with small datasets using current methods does not produce reliable models. In many situations, the dataset needed to effectively train a neural network model does not exist and would require years to obtain. Even in situations where the dataset exists, training a neural network model for accurate prediction takes years and requires large data centers with thousands of computers. Training of neural network models using less than 1 million records requires an understanding of why the layer parameters underfit or overfit not available using conventional training techniques.

Aspects of the present disclosure relate to a system implemented as computer programs on one or more computers in one or more locations. The disclosed system determines an architecture for efficient search of anomalous patterns in neural network layer parameters. Neural network models can have millions of parameters or even orders of magnitude more. Identifying anomalous parameters in models with existing techniques does not work regardless of the hardware used to perform the operation. As models continue to increase in parameter count, an efficient search is needed to understand the parameters, reduce training time, and improve the accuracy. The results of the search identify the layer parameters contributing to anomalous patterns, i.e., underfitting and overfitting. The results of the search can be used to modify layer parameters thus improving accuracy and loss on training, validation, and test datasets without requiring that new records be added to the datasets.

The neural network can be trained to perform any kind of machine learning task, i.e., it can be configured to receive any kind of digital data input and to generate any kind of score, classification, or regression output based on the input data.

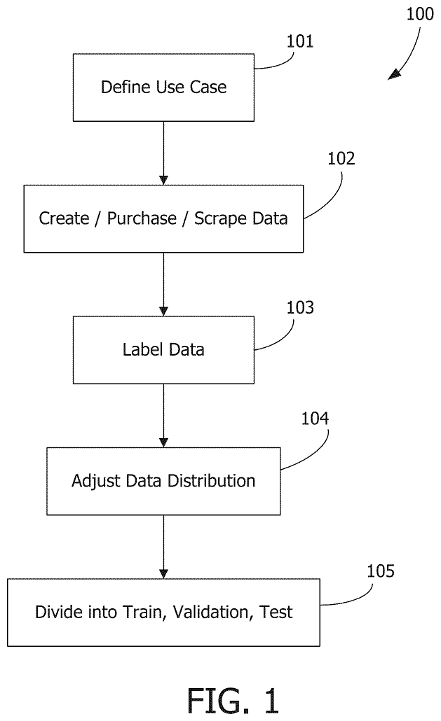

FIG. 1 shows an example process 100 embodying aspects of the present disclosure for creating one or more digital datasets suitable for training neural network models. Beginning at 101, defining a use case is an iterative process that evolves as the neural network model is trained. At 102, creating the dataset may include additional sub processes such as cleansing, deduplication, filtering, down scaling, sampling, and/or augmentation to improve the quality of the dataset. Labeling the record at 103 is preferably performed by an automated process executed by one or more computer programs or by combination of automated and human processes. Adjusting the dataset distribution at 104 attempts to make a balanced dataset and reduce bias and skew. At 105, the process 100 divides the dataset into training, validation, and test subsets using, preferably, a random selection process.

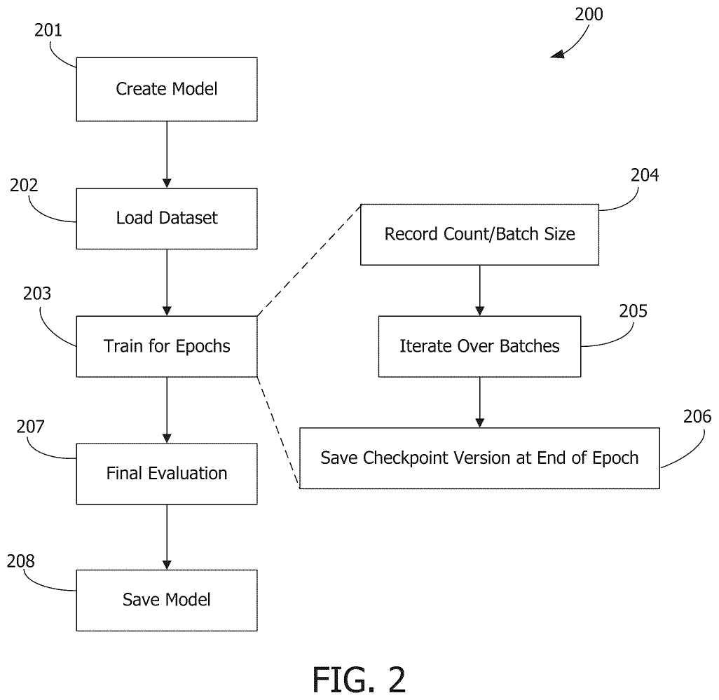

FIG. 2 illustrates an example process 200 embodying aspects of the present disclosure for creating and training a neural network model. Beginning at 201, the process 200 creates the model, which may be one or more models have different configuration of hidden layers, activation functions, and parameters. Loading the dataset at 202 comprises reading the necessary datasets from some a storage medium, which may be a local device or a network device. Proceeding to 203, training for epochs is the process of iterating through the entire training and validation datasets. As described above, each of the epochs represents a complete iteration of the dataset by the neural network model. In other words, one complete iteration over the training and validation datasets is one epoch. The process 200 further comprises subprocesses 204 to 206 for performing operations to iterate over the records in a manner to avoid hardware limitations (e.g., the availability of memory). At 204, batch calculation divides the number of records in the given dataset by a batch size for determining, at 205, the batch iterations needed to process the entire dataset. A checkpoint version is saved at the end of the epoch at 206 and includes writing the layer parameters to a storage medium, which may be a local device or a network device. The number of checkpoint versions at the end of one training session is equal to the number of epochs defined at the start of the training session.

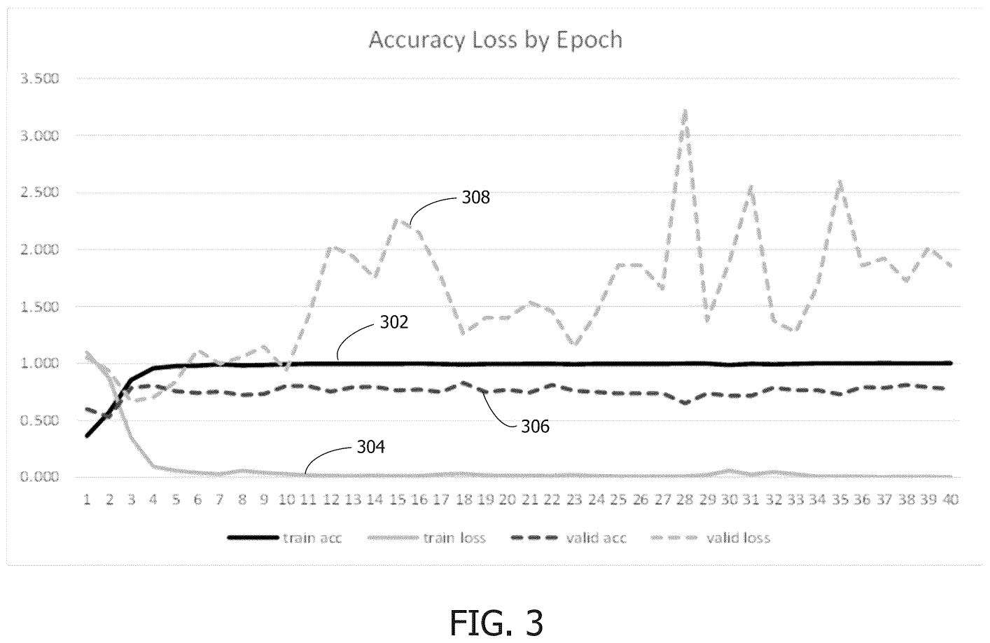

FIG. 3 illustrates example accuracy and loss performance of partially trained models on the training and validation datasets. On the x-axis are the epochs. On the y-axis are accuracy and loss at a given epoch expressed as decimal values. The solid lines 302, 304 illustrate the accuracy and loss, respectively, of the training dataset. The dashed lines 306, 308 illustrates the accuracy and loss, respectively, of the validation dataset. In other words, the lines 302 and 306 represent the accuracy at a given epoch; the lines 304 and 308 represent the loss at a given epoch. In an ideal training session, the loss would move towards zero indicating the probability of a bad prediction is low. In an ideal training session, the accuracy would move towards 1 indicating the probability of a correct prediction is high. The graph illustrates overfitting to the training dataset begins after the tenth epoch as indicated by line 308. The line 306 illustrates how accuracy on the validation dataset plateaus and may not achieve the desired accuracy.

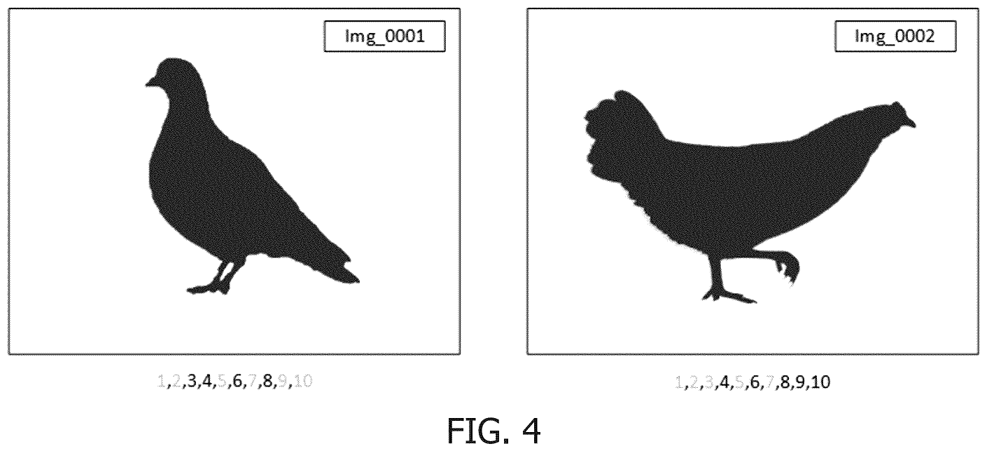

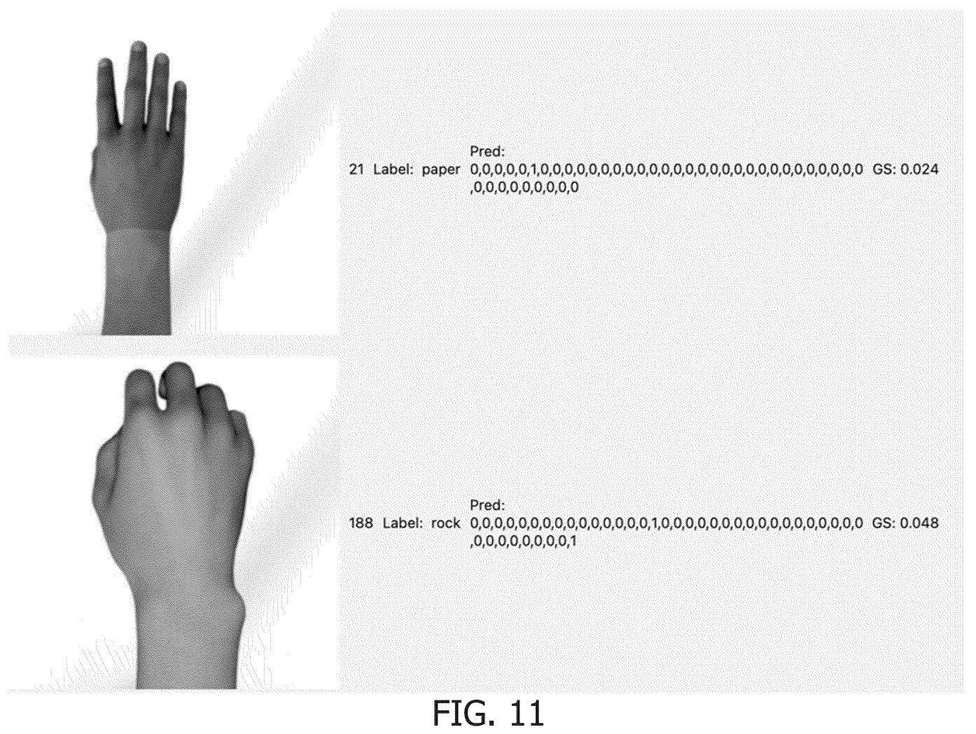

FIG. 4 illustrates one possible embodiment of visualizing the accuracy and loss for each record in the dataset over the training session. The visualization indicates a successful prediction at a given epoch by highlighting the text for the epoch. A simpler embodiment of the visualization is a sequence of 0's and 1's where 0 is a wrong prediction and 1 is a correct prediction as illustrated by FIG. 11. The search function utilizes the same information to select epochs for additional analysis. Visualizing the accuracy over the training session provides insight on anomalies and aids in understanding layer parameters.

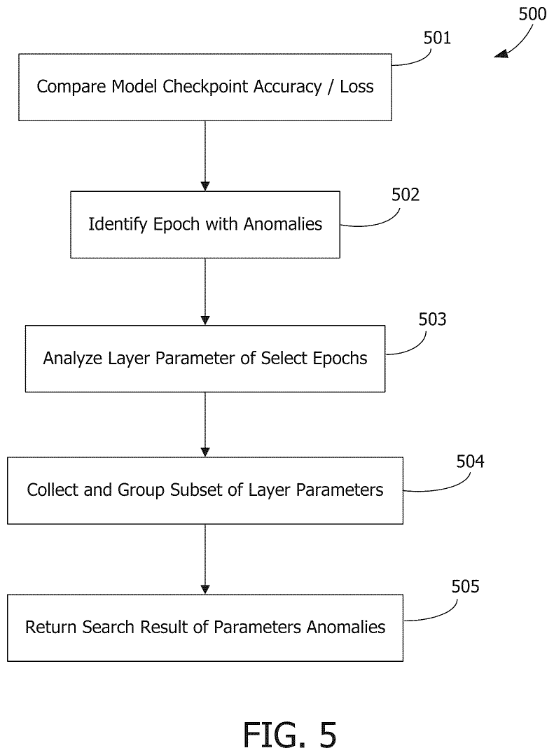

FIG. 5 illustrates an example process 500 for performing a search operation. Beginning at 501, the process 500 compares checkpoint accuracy and loss and creates a detailed report of the positive and negative predictions for the training and validation datasets. The report groups the prediction results by record, which can be used for visualization or search operation. Identifying epochs with anomalies at 502 reduces the search space and makes the operation more efficient. At 503, the process 500 analyzes layer parameters to identify anomalous patterns by comparing the parameter changes between checkpoints. Collecting and grouping a subset of layer parameters at 504 sorts the results. At 505, the search results of parameter anomalies are returned as the final output of the search operation.

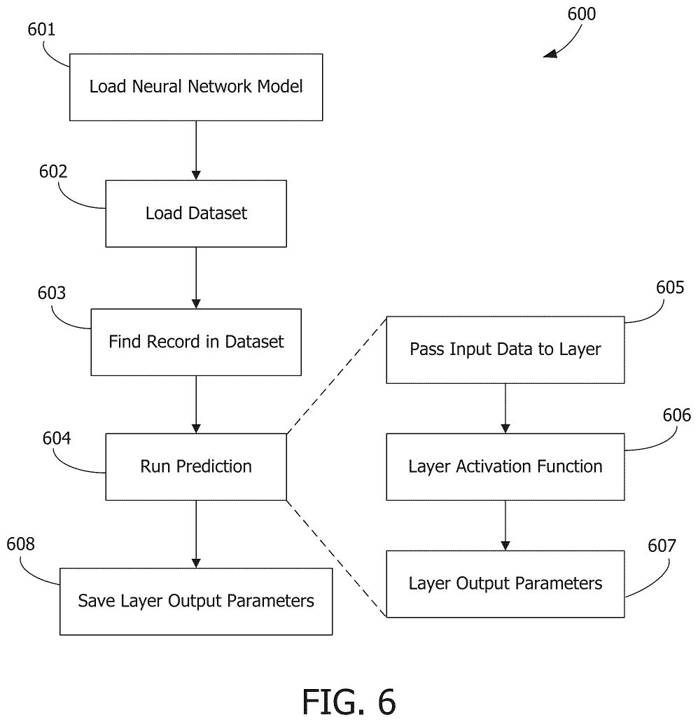

FIG. 6 illustrates an example process 600 for profiling a single execution of the neural network model and saving the layer outputs for additional analysis. At 601, the neural network model reads the saved checkpoint model from a storage medium. Loading the dataset at 602 comprises reading the same dataset used to train the neural network model from the storage medium. Proceeding to 603, the process 600 finds a record in the dataset by iterating over the dataset and retrieving the record to profile. A run prediction step at 604 converts the record to the appropriate format and passes the data to the input layer of the neural network model. The process 600 further comprises subprocesses 605 to 607 for sending the data to the hidden layers of the neural network model. At 605, the input data is received from the previous layer output. A layer activation function at 606 then applies an activation function on the layer parameters and input data. The process 600 continues at a layer output parameters step 607, which is the result of the layer activation function. Saving the layer output parameters at 608 includes collecting the list of outputs from each layer and saving it to a storage medium. The search operation may use the layer output data to refine the search criteria. The search operation may optionally compare layer output of multiple checkpoint versions to determine which layer parameters contribute to underfitting or overfitting.

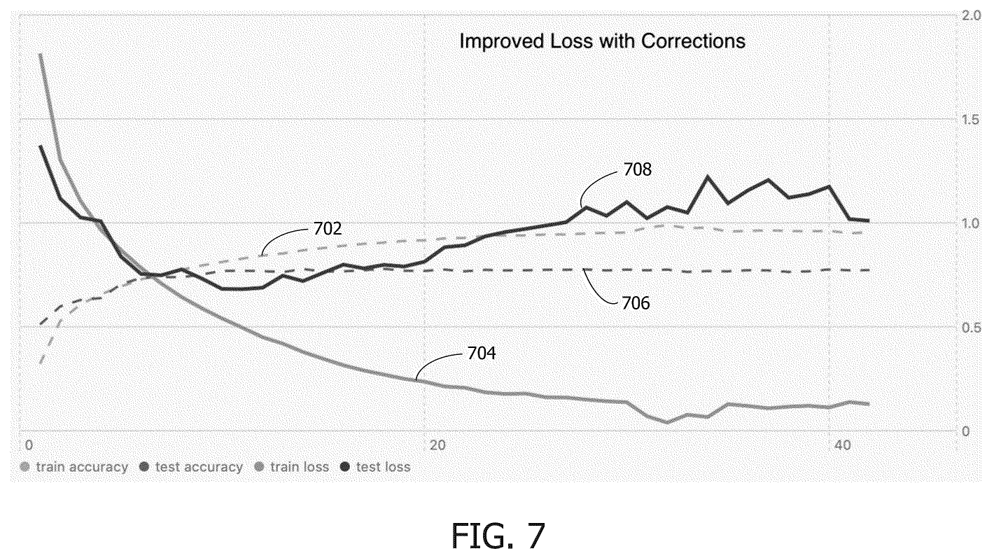

FIG. 7 illustrates the accuracy and loss performance of partially trained models after layer parameters are modified with the results of the anomaly pattern search. The lines 702, 704 illustrate the accuracy and loss, respectively, of the training dataset. The lines 706, 708 illustrates the accuracy and loss, respectively, of the validation dataset. The validation loss 708 has a significant improvement after the layer parameters are modified with the search results. Once the layer parameters have overfit to the training dataset, loss on the validation dataset becomes unpredictable. Training the neural network model for additional epochs generally does not resolve the degradation problem. Common techniques for resolving overfitting is to add more records to the training dataset, randomly reset layer parameters, or combination of both. Modifying the layer weights with the anomaly search results does not require adding records to the training dataset and produces an immediate improvement in validation loss.

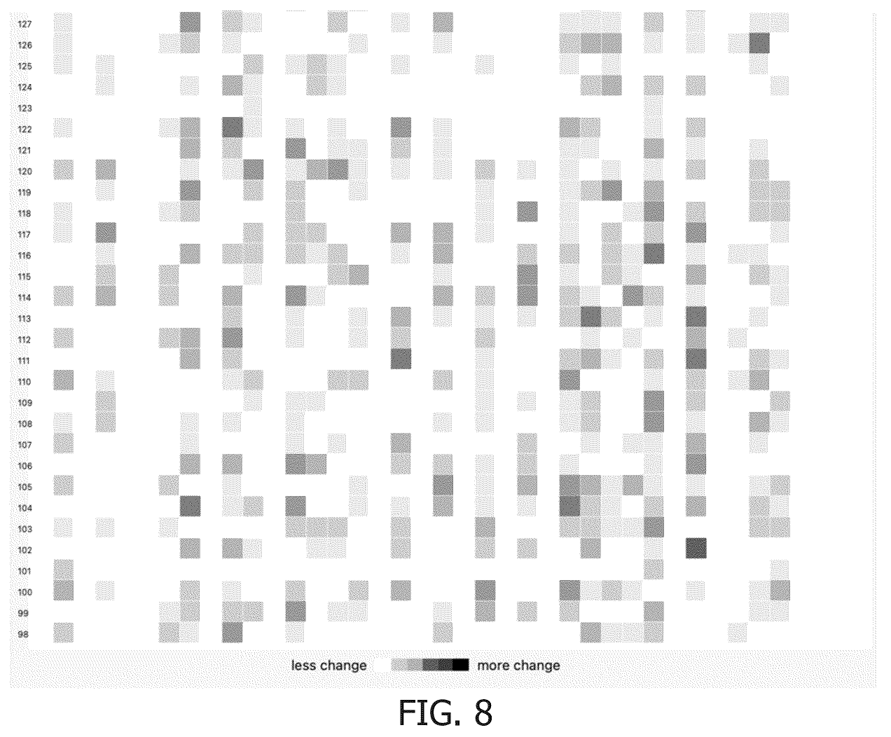

FIG. 8 illustrates one possible embodiment of visualizing the changes to layer parameters between one or more versions of the model checkpoints in the form of a heatmap. The benefit of visualizing the layer weight changes between checkpoint versions is it provides additional data to explore and understand the cause of underfitting and overfitting.

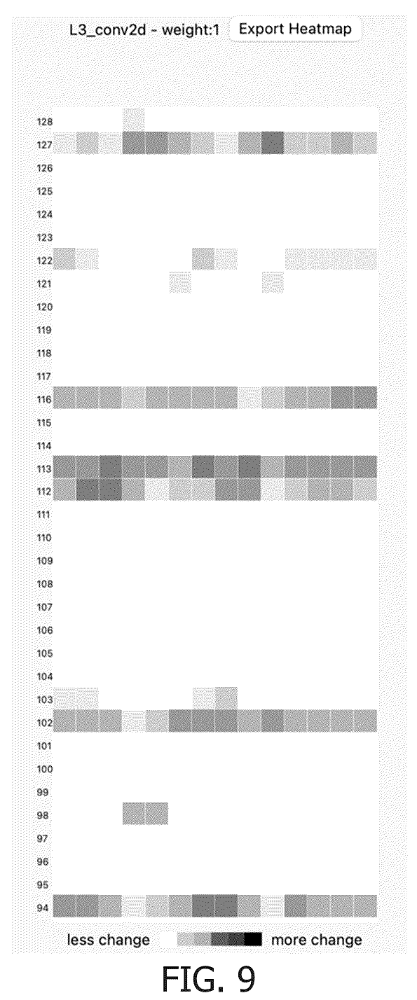

FIG. 9 illustrates one possible embodiment of visualizing the layer outputs produced by the activation function for a single execution of prediction on one record in the form of a heatmap. The benefit of visualizing the layer outputs is it provides a way to identify the layer parameters contributing to anomalous behavior. The search function can utilize the information to refine the search criteria.

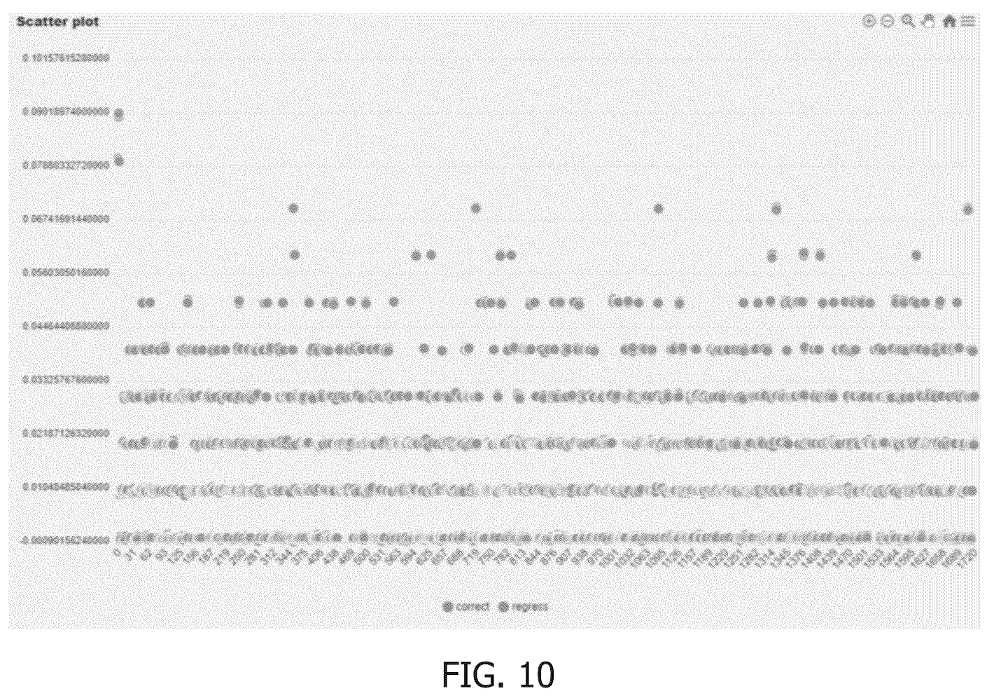

FIG. 10 illustrates one possible embodiment of visualizing the search results of anomalous patterns in the layer parameters in the form of a scatter plot. The benefit of visualizing the search results is it illustrates hidden patterns causing anomalous behavior in a format that is easier for engineers to comprehend. It is common for a hidden layer to have 200,000 or millions parameters, which is impossible for engineers to comprehend. Visualizing anomalous parameters is only possible with an efficient and accurate search. Existing training techniques randomly adjust the dataset, model layers, loss function or training configuration to improve accuracy, but do not consistently produce good results. Many companies fail to produce a model good enough to sell using existing training methods after spending years training models on tens of thousands of GPUs.

The training example in FIG. 7 shows the loss began to degrade around epoch 20 of the training session. Continuing to train from epoch 40 without identifying and adjusting parameter anomalies would see the loss continue to grow. When training exhibits this behavior, the prediction accuracy never improves and loss continues to degrade to the point where accuracy starts to degrade.

FIG. 11 illustrates the prediction accuracy for each test record with a record generalization score that indicates how well the model generalized to the record. The record generalization score provides additional information for parameter search. The mean of the generalization scores for the test dataset provides an estimate of how well the model generalized for data not in the training dataset. The mathematical expression for record generalization score and mean training prediction error is expressed by the following formula:

$$Pi = {\sum }_{j = 1}^{n} Pi , j$$

$$RGSi = \frac{Pi}{n}$$

$$MTPE = \frac{{\sum }_{i = 1}^{n} RGSi}{n}$$

Pi is initialized as zero and incremented by one for each correct prediction from 1 to n. Record generalization score is Pi divided by n. Mean training prediction error is the sum of record generalization scores divided by n.

One or more embodiments of the present disclosure described herein can be implemented so as to realize one or more of the following advantages.

By identifying the layer parameters contributing to anomalous patterns as described in this specification, the system can identify subset of parameters in a layer that contribute to underfitting and overfitting. In other words, identifying the subset of layer parameters causing underfitting and overfitting can result in the neural network being able to converge quickly by reducing anomalous patterns that produce undesirable side-effects in prediction performance.

By identifying the layer parameters contributing to anomalous patterns, the system can visualize the layer parameters as heatmaps, plots, graphs and charts to assist refinement of the training, validation and test dataset, which can result in reducing training time.

By identifying the layer parameters contributing to anomalous patterns with user created data, the system can reduce the resources needed to manage and enhance the training dataset. In other words, identifying the layer parameters causing negative predictions on user created data reduces the resource and time needed to improve the neural network model to obtain better accuracy and loss on data not present in the training dataset.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A computer-implemented method when executed on data processing hardware causes the data processing hardware to perform operations comprising:
acquiring at least one digital dataset;
training a neural network model using the dataset, the neural network model comprising a plurality of layers, each of the layers comprising a plurality of layer parameters;
analyzing accuracy and loss of a partially trained version of the neural network model following each of one or more epochs to identify when an epoch corresponds to an anomalous pattern, the epochs each representing a complete iteration of the dataset by the neural network model;
searching the layer parameters of the partially trained version of the neural network model for the identified epoch corresponding to the anomalous pattern to identify the layer parameters contributing to the anomalous pattern;
modifying a subset of the layer parameters of the partially trained neural network model with the layer parameters identified by the searching; and
applying the modified subset of the layer parameters to the neural network model.

2. The computer-implemented method of claim 1, wherein the epoch corresponding to the anomalous pattern is a subset of one or more partially trained versions of the neural network model.

3. The computer-implemented method of claim 1, wherein searching the layer parameters of the partially trained version of the neural network model comprises performing a search operation to compare the layer parameters between partially trained versions of the neural network model and identify the layer parameters contributing to the anomalous pattern.

4. The computer-implemented method of claim 3, wherein the search operation returns the subset of the layer parameters for one or more of the layers contributing to the anomalous pattern.

5. The computer-implemented method of claim 3, wherein applying the modified subset of the layer parameters to the neural network model comprises loading the partially trained version of the neural network model with the subset of the layer parameters returned by the search operation to generate a modified version of the neural network model.

6. The computer-implemented method of claim 5, further comprising generating a detailed report of accuracy and loss for the dataset for the modified version of the neural network model.

7. The computer-implemented method of claim 1, further comprising generating a detailed report of accuracy and loss for the dataset for each partially trained version of the neural network model.

8. The computer-implemented method of claim 7, wherein generating the detailed report includes positive and negative prediction details for each record in the dataset for all partially trained versions of the neural network model.

9. The computer-implemented method of claim 1, wherein the anomalous pattern comprises at least one of underfitting and overfitting.

10. The computer-implemented method of claim 1, further comprising determining the accuracy and loss of the neural network model after applying the modified subset of the layer parameters thereto.

11. The computer-implemented method of claim 1, further comprising generating a record generalization score representing a prediction accuracy for each test record of the dataset.

12. A computer-implemented method when executed on data processing hardware causes the data processing hardware to perform operations comprising:
training a neural network model, the neural network model comprising a plurality of layers, each of the layers comprising a plurality of layer parameters;
saving a partially trained version of the neural network model on a computer-readable storage medium following each of one or more epochs, the epochs each representing a complete iteration of a training dataset by the neural network model;
generating a detailed report of accuracy and loss for the dataset for each partially trained version of the neural network model;
identifying, based on the accuracy and loss, when an epoch corresponds to an anomalous pattern;
searching the layer parameters of the partially trained version of the neural network model for the identified epoch corresponding to the anomalous pattern to identify the layer parameters contributing at least one of underfitting and overfitting;
modifying a subset of the layer parameters of the partially trained neural network model with the layer parameters identified by the searching; and
determining the accuracy and loss of the neural network model after the subset of the layer parameters has been modified.

13. The computer-implemented method of claim 12, wherein the computer-readable storage medium for saving the partially trained version of the neural network model comprises a local device or a network device.

14. The computer-implemented method of claim 12, wherein the epoch corresponding to the anomalous pattern is a subset of one or more partially trained versions of the neural network model.

15. The computer-implemented method of claim 12, wherein searching the layer parameters of the partially trained version of the neural network model comprises performing a search operation to compare the layer parameters between partially trained versions of the neural network model and identify the layer parameters contributing to the anomalous pattern.

16. The computer-implemented method of claim 15, wherein the search operation returns the subset of the layer parameters for one or more of the layers contributing to the anomalous pattern.

17. The computer-implemented method of claim 12, further comprising loading the partially trained version of the neural network model with the subset of the layer parameters returned by the search operation to generate a modified version of the neural network model.

18. The computer-implemented method of claim 17, further comprising saving the modified version of the neural network model on the computer-readable storage medium.

19. The computer-implemented method of claim 12, wherein generating the detailed report includes positive and negative prediction details for each record in the dataset for all partially trained versions of the neural network model.

20. The computer-implemented method of claim 12, further comprising generating a record generalization score representing a prediction accuracy for each test record of the dataset.
